(19) United States
(12) Patent Application Publication
(10) Pub. No.: US 2008/0062266 A1
(43) Pub. Date: Mar. 13, 2008

(54) IMAGE TEST BOARD

(75) Inventors: Jia-Yang Chang, Hsinchu Hsien (TW); Chao-hsiung Su, Hsinchu City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/530,918

(22) Filed: Sep. 12, 2006

(51) Int. Cl. H04N 17/00

(52) U.S. Cl. 348/188

(57) ABSTRACT

A method for testing an image capture device. The method for testing an image capture device comprises providing an image test board printed with at least two positioning marks and at least one test pattern, the at least one test pattern being positioned in a coordinate system defined by the at least two positioning marks, capturing a test image of the image test board with the image capture device, locating the at least two positioning marks in the test image to find the coordinate system, and analyzing the at least one test pattern in the test image in accordance with the coordinate system to verify the quality of the image capturing device.

### BACKGROUND OF THE INVENTION

1. Field of the Invention

The invention relates to an image test board, and more specifically to an image test board for camera quality testing.

2. Description of the Related Art

In testing image capture devices in manufacturing process, such as digital cameras or mobile phones with cameras, an image capture device is usually disposed on a support to capture a test target, generating a test image. The test image is accordingly analyzed with image analysis software by a computer to evaluate the quality of the image capture device. The test target is generally a test board having a reference test chart including a certain number of test patterns with number and type dependent upon the analysis to be carried out thereon. For example, FIG. 1 shows an I3A/ISO Camera Resolution Chart. To accurately analyze the quality of the test image, the position of test patterns in the test image must lie within predetermined tolerance range of the image analysis software. Otherwise, re-testing or utilizing larger test patterns to obtain larger tolerance ranges in test equipment and procedures is required. However, more image cards for quality testing and more time to finish all test patterns are required, increasing effort and time. Moreover, the image capture devices for testing are manually aligned in front of the test board, increasing possible error. Thus, it is desirable to have an image test board which can improve the efficiency of the test procedure, reducing time required for test and production cost.

### BRIEF SUMMARY OF THE INVENTION

A detailed description is given in the following embodiments with reference to the accompanying drawings.

The invention is generally directed to a method for testing an image capture device. An exemplary embodiment of a method for testing an image capture device comprises providing an image test board printed with at least two positioning marks and at least one test pattern, the at least one test pattern being positioned in a coordinate system defined by the at least two positioning marks, capturing a test image of the image test board with the image capture device, locating the at least two positioning marks in the test image to find the coordinate system, and analyzing the at least one test pattern in the test image in accordance with the coordinate system to verify the quality of the image capturing device.

A test platform for testing an image capture device in a manufacturing process is provided. The test platform comprises a surface portion, a support, and a computer system. The surface portion is printed with at least two positioning marks and defining an attaching area for attaching an image chart in a coordinate system defined by the at least two positioning marks. The support supports the image capture device to capture a test image of the image chart and the at least two positioning marks. The computer system, coupled to the image capture device, receives the test image and verifies the quality of the image capture device by analyzing the test image with the coordinate system in the test image, wherein the coordinate system in the test image is found by locating the at least two positioning marks.

Further, an image card for testing an image capture device in a manufacturing process is provided. The image card comprises a card surface, at least two positioning marks, and at least one test pattern. The at least two positioning marks are printed on the card surface defining a coordinate system. The at least one test pattern is printed on the card surface within an area defined by the at least two positioning marks. The image capture device captures a test image of the at least one test pattern and the at least two positioning marks and the test image is analyzed to verify the quality of the image capture device with the coordinate system in the test image found by locating the positioning marks in the test image.

### BRIEF DESCRIPTION OF THE DRAWINGS

The invention can be more fully understood by reading the subsequent detailed description and examples with references made to the accompanying drawings, wherein:

FIG. 1 is a schematic diagram of an I3 A/ISO Camera Resolution Chart.

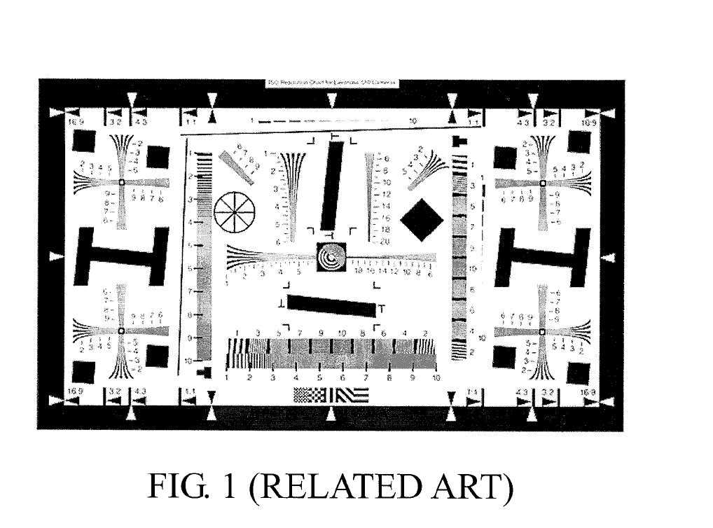

FIG. 2 is a schematic diagram of a test platform according to an embodiment of the invention.

FIG. 3 is a schematic diagram of the image test board of FIG. 2.

FIG. 4 is a schematic diagram of an exemplary image test board.

FIG. 5 shows a test image generated by the image capture device of FIG. 2 shooting the image test board of FIG. 4.

FIG. 6 shows a flowchart of a method of locating the positioning marks in the test image of FIG. 5.

FIG. 7 shows the test image of FIG. 5after step 602.

FIG. 8 shows an example illustrating the single link clustering process.

FIG. 9 shows the test image of FIG. 5 after steps 604 and 606.

FIG. 10 is a schematic diagram of an image card according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

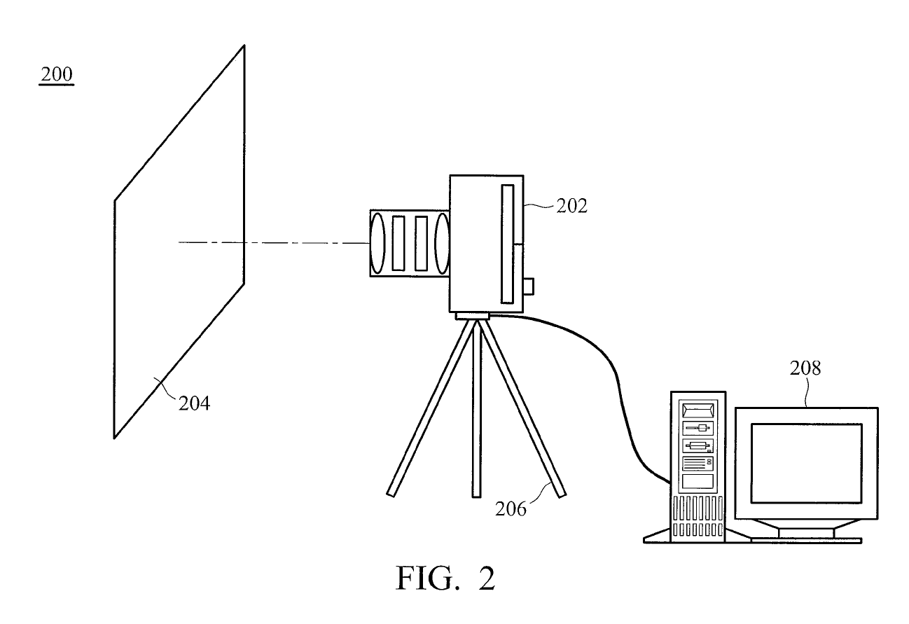

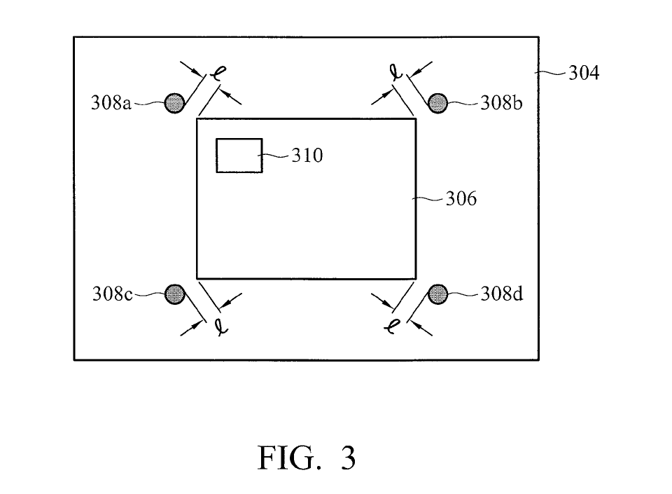

FIG. 2 is a schematic diagram of a test platform 200 for testing an image capture device 202 in a manufacturing process. The test platform 200 comprises an image test board 204, a support 206, and a computer system 208. The support 206 supports the image capture device 202, such as a digital camera, to aim at the image test board 204, generating a test image of the image test board 204. The computer system 208, coupled to the image capture device 202, receives the test image therefrom to verify the quality of the image capture device 202 by analyzing the test image. FIG. 3 is a schematic diagram of the image test board 202 of FIG. 2. The image test board 202 comprises a positioning platform 304 and an image chart 306. At least two positioning marks 308 are printed on the positioning platform 304, with the positioning platform 304 shown printed with four positioning marks 308a˜d. The color of the positioning marks 308a˜d is predetermined and different from the background color of the positioning platform 304, wherein the predetermined color of the positioning marks 308a˜d is stored in advance in the computer system 208. The positioning marks 308a˜d define an attaching area for the image chart 306 and a coordinate system. The image chart 306 is then attached to the area of the positioning platform 304 defined by the positioning marks 308a˜d and placed in the coordinate system defined by the positioning marks 308a˜d, wherein the minimum distance l between the image chart 306 and the positioning marks 308a˜d is greater than the diameter of the positioning marks 308a˜d. The image chart 306 comprises at least one test pattern 310, wherein different test patterns can be utilized for desired image analysis.

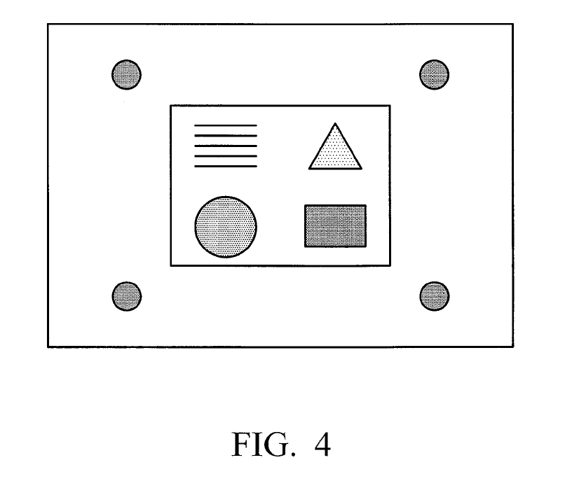

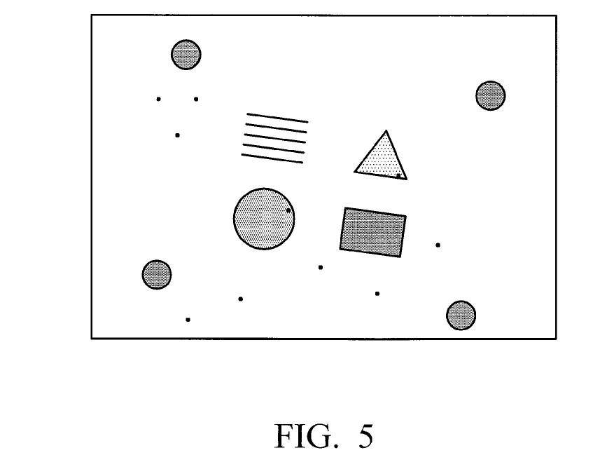

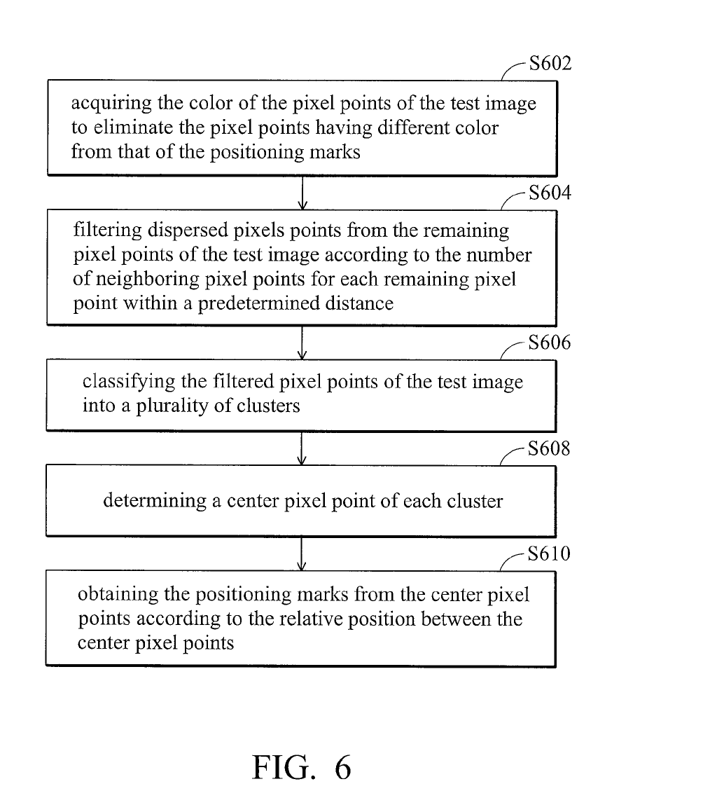

FIG. 4 is a schematic diagram of an exemplary image test board 204. FIG. 5 shows a test image 500 generated by the image capture device 202 shooting the image test board 204 of FIG. 4. The test image 500 is analyzed by locating the positioning marks 308a˜d thereof, and thus the test pattern 310 of the image chart, 306 can be located with the coordinate system defined by the located positioning marks 308a˜d. FIG. 6 is a flowchart of a method 600 of locating the positioning marks 308a˜d in the test image 500. In step 602, the color of the pixel points P(x,y) of the test image 500 is acquired to eliminate the pixel points P(x,y) of the test image 500 having different color from that of the positioning marks 308a˜d, wherein P(x,y) represents the pixel points of the test image 500 with coordinate value (x,y). Since the color of the positioning marks 308a˜d is predetermined, the corresponding color information can be obtained from the computer system 208. Formula 1 is an exemplary method to eliminate the pixel points P(x,y) having different color of that of the positioning marks 308a˜d Cp, with assuming the color of the positioning marks 308a˜d being Cp.

(R(P(x,y))−RofCp)²+(G(P(x,y))−GofCp)²+(B(P(x,y))−BofCp)²<BoundA (1)

wherein P(x,y) represents the pixel point of the test image 500 with coordinate value (x,y); R(P(x,y) represents the red component value of the pixel point P(x,y); G(P(x,y) represents the green r component value of the pixel point P(x,y), B(P(x,y) represents the blue component value of the pixel point P(x,y), RofCp represents the red component value of the color of the positioning marks 308a˜d Cp; GofCp represents the green component value of the color of the positioning marks 308a˜d Cp; BofCp represents the blue component value of the color of the positioning marks 308a˜d Cp and BoundA represents a predetermined color threshold.

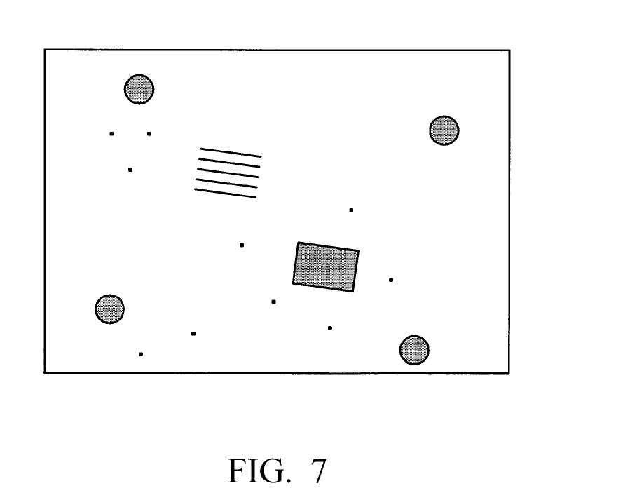

In Formula (1), the colors of the pixel points P(x,y) of the test image 500 and the positioning marks 308a˜d with respect to red, green and blue components are computed with a square error (SE) operation and each of the SE results is summed to obtain a total color SEₜₒₜₐₗ wherein only the pixel point P(x,y) of the test image 500 with total color SEₜₒₜₐₗ is less than BoundA is reserved for further processing while others are eliminated. FIG. 7 shows the test image 500 after step 602. It is observed that only the pixel points P(x,y) of the test image 500 having similar color is remain. Formula (1) is merely an exemplary method of eliminating the pixel points P(x,y) of color other than that of the positioning marks 308a˜d Cp, those skilled in the art can also utilize other methods in accordance with the principle disclosed.

Proceeding to step S604, the dispersed pixels points of the test image 500 are filtered according to the number of neighboring pixel points for each remaining pixel point within a predetermined distance. In step S604, the number of neighboring pixel points of each pixel point P(x,y) of the test image 500 within the predetermined distance d is calculated. The pixel point P(x,y) of the test image 500 is then filtered if the calculated number of neighboring pixel points of the pixel point P(x,y) within the predetermined distance d is less than a predetermined grouping threshold ThresholdB. For example, if d is 3, the maximum the number of neighboring pixel points of a pixel point P(x,y) is 24, thus ThresholdB may be set as 24*0.9=21. That is, combining steps S602 and S604, if more than 10 percent of the neighboring pixel points of the pixel point P(x,y) are of different color than the pixel point P(x,y), the pixel point P(x,y) is filtered from the processing. Following step S604, the method 600 proceeds to step S606.

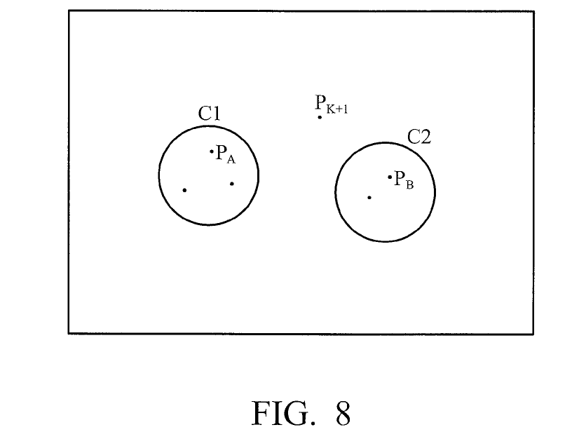

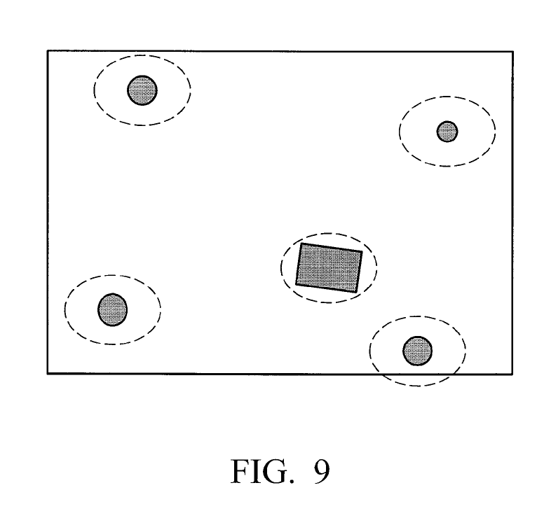

In step S606, the remaining pixel points P(x,y) of the test image 500 are classified into a plurality of clusters. An exemplary classification method is single link clustering process. FIG. 8 shows an example illustrating the single link clustering process. It is assumed that there are two clusters C1 and C2, and the distance between all pixel points in each cluster is less than d2. To classify the (k+1)^{st} pixel point Pₖ₊₁, the distance of the pixel point Pₖ₊₁ from the other pixel points is calculated. If the distance between the pixel point Pₖ₊₁ and a pixel point Pₘ is less than d2, the pixel point Pₖ₊₁ is classified into the same group as pixel point Pₘ. If the distance between the (k+1)^{st} pixel point Pₖ₊₁ and all other pixel points exceeds d2, a new cluster is formed, comprising only the (k+1)^{st} pixel point Pₖ₊₁. However, if there is more than one pixel point with distance to the (k+1)^{st} pixel point Pₖ₊₁ within d2, for example, if both distances between the pixel point Pₖ₊₁ the pixel point P_{A} in cluster C1 and the pixel point P_{B} in cluster C2 are respectively less than d2, clusters C1 and C2 are merged into one cluster. FIG. 9 shows the test image 500 after steps 604 and 606, wherein a circle represent a cluster of pixel points.

Proceeding to step S608, a center pixel point P_{Center} of each cluster is determined. Before finding the center pixel point of each cluster, the cluster having pixel points fewer than a predetermined clustering threshold ThresholdC may be filtered first. For example, if there are only nine pixel points in the cluster C1 and the ThresholdC is 10, the cluster C1 will be filtered. Further, an exemplary method of finding the center pixel point of each cluster comprises calculating an average x-coordinate value and an average y-coordinate value of the x-coordinate and y-coordinate of the pixel points of each cluster respectively in the test image 500 of FIG. 9 and taking the calculated average x-coordinate value and y-coordinate values of each cluster as the x-coordinate and y-coordinate of a center pixel point P_{Center} for each cluster.

In step S610, the positioning marks 308a˜d in the test image 500 are obtained from the center pixel points P_{Center} according to the relative position between the center pixel points. Firstly, the center pixel points with maximum or minimum x-coordinate or y-coordinate value are identified, and the number are from 2 to 4. If the number is less than 4, the two points with largest distance are selected to draw a line on them and the other two center pixels points with largest distance to this line on each side are then identified. With further comparison of relative position between the four center pixel points P_{Center}, each of the positioning marks 308a˜d in the test image 500 can be identified. For example, the center pixel point P_{Center} having a maximum x-coordinate value and a minimum y-coordinate value is the positioning mark 308a of the test image 500 corresponding to the positioning marks 308a of the image chart 306.

With the located positioning marks 308a˜d in the test image 500, the coordinate system defined thereby can be found, wherein the position of the pixel points of the image chart 306 in the test image 500 therein can be located with reference to the located positioning marks 308a˜d. For example, for a pixel point in the image chart 306 with coordinate (x,y), the coordinate values (x′,y′) of the pixel point in the test image 500 can be obtained with the formulae:

x′=X0′+x*(X1′−X0′)/(X1−X0)+y*(X2′−X0′)/(Y2−Y0);

y′=Y0′+x*(Y1′−Y0′)/(X1−X0)+y*(Y2′−Y0′)/(Y2−Y0);

wherein (X0,Y0), (X1,Y1), (X2,Y2), (X3,Y3) represent the coordinates in the positioning marks 308a˜d of the positioning platform 304 respectively and (X0′,Y0′), (X1′,Y1′), (X2′,Y2′), (X3′,Y3′) represent the coordinates of the positioning marks 308a˜d in the test image 500 respectively and are obtained after step S610. Errors in image quality analysis caused by mechanism and operation can be reduced, since the positions of the pixel points in the test image can be accurately obtained with the located positioning marks. The testing time and production cost are accordingly reduced.

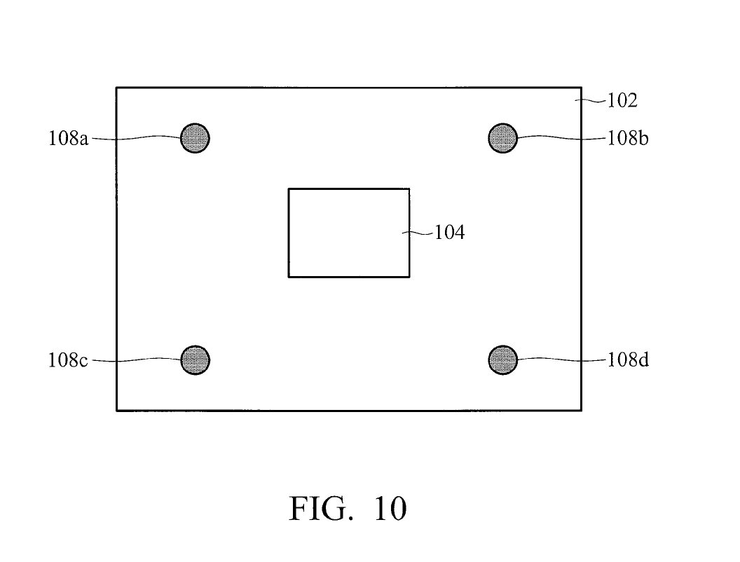

However, the positioning marks need not necessarily be printed on the positioning platform 304, they can be printed on the image chart 306, improving mobility. FIG. 10 is a schematic diagram of an image card 10 for testing an image capture device in a manufacturing process. The image card 10 comprises a card surface 102, at least two positioning marks 108a˜d printed on the card surface defining a coordinate system, and at least one test pattern 104 printed on the card surface 102 within an area defined by the at least two positioning marks. The image capture device captures a test image of the at least one test pattern 104 and the at least two positioning marks 108a˜d. The test image is then analyzed to verify the quality of the image capture device with the coordinate system in the test image found by locating the positioning marks in the test image. The positioning marks 1 08a˜d can be located by the stated method, however, as stated; other methods may be employed. Moreover, while the positioning marks in the embodiment of FIG. 3 are four round spots, other types of positioning marks can be utilized, such as square spots, and at least two positioning marks will be sufficient. The image test platform, location method and image card of the invention can be used for quality control of image capture devices, wherein the image capture device may be a digital camera or other devices with a camera, such as a mobile phone having a digital camera.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for testing an image capture device, comprising:
providing an image test board printed with at least two positioning marks and at least one test pattern, the at least one test pattern being positioned in a coordinate system defined by the at least two positioning marks;
capturing a test image of the image test board with the image capture device;
locating the at least two positioning marks in the test image to find the coordinate system; and
analyzing the at least one test pattern in the test image in accordance with the coordinate system to verify the quality of the image capture device.

2. The method as claimed in claim 1, wherein the number of the positioning marks is three and the positioning marks are round.

3. The method as claimed in claim 1, wherein the number of the positioning marks is four and the positioning marks are round.

4. The method as claimed in claim 1, wherein the image test board comprises a positioning platform and an image chart, the at least two positioning marks are printed on the positioning platform and the at least one test pattern is printed on the image chart.

5. The method as claimed in claim 1, wherein the color of the positioning marks is predetermined and different from a background color of the image test board.

6. The method as claimed in claim 5, wherein locating the at least two positioning marks comprises:
acquiring the color of the pixel points of the test image to eliminate pixel points of color different from the positioning marks;
filtering dispersed pixel points from the remaining pixel points of the test image according to the number of neighboring pixel points for each remaining pixel point within a predetermined distance;
classifying the filtered pixel points of the test image into a plurality of clusters;
determining a center pixel point of each cluster; and
obtaining the positioning marks from the center pixel points according to the relative positions among the center pixel points.

7. The method as claimed in claim 6, wherein acquiring the color of the pixel points of the test image to eliminate pixel points with color different from the positioning marks comprises:
obtaining the color of the positioning marks and the pixel points of the test image with respect to red, green and blue components thereof respectively;
computing a first square error, a second square error and a third square error associated with the red, green and blue components of the positioning marks and each pixel point of the test image respectively; and
eliminating a pixel point of the test image if the summation of the first, second and third square errors thereof exceeds a predetermined color threshold.

8. The method as claimed in claim 6, wherein filtering dispersed pixel points from the remaining pixel points of the test image according to the number of neighboring pixel points for each remaining pixel point within a predetermined distance comprises:
calculating the number of neighboring pixel points of each remaining pixel point of the test image within the predetermined distance; and
filtering a pixel point of the image if the calculated number of neighboring pixel points of the pixel point within the predetermined distance is less than a predetermined grouping threshold.

9. The method as claimed in claim 6, further comprising after classifying, filtering a cluster if the number of pixel points thereof is less than a predetermined clustering threshold.

10. The method as claimed in claim 6, wherein classifying comprises applying a single link clustering process.

11. The method as claimed in claim 6, wherein determining a center pixel point of each cluster comprises:
calculating an average x-coordinate value and an average y-coordinate value of the x-coordinate and y-coordinate of the pixel points of each cluster respectively; and
using the calculated average x-coordinate value and y-coordinate values of each cluster as the x-coordinate and y-coordinate of the center pixel point of each cluster.

12. The method as claimed in claim 6, wherein obtaining the positioning marks from the center pixel points according to the relative position among the center pixel points comprises:
a. finding positioning marks by identifying central pixel points that have the largest x coordinate, the largest y coordinate, the smallest x coordinate and the smallest y coordinate; and
b. if the number of position marks found in step a is less than four, finding other one or more positioning marks by identifying central pixel points that have the largest distance to a line from two sides of the line, where the line is defined by two of the central pixel points with the largest distance therebetween.

13. The method as claimed in claim 1, wherein the image capture device is a digital camera.

14. The method as claimed in claim 1, wherein the image capture device is an electronic device having a camera.

15. A test platform for testing an image capture device in a manufacturing process, comprising:
a surface portion printed with at least two positioning marks, the surface portion defining an attaching area for attaching an image chart in a coordinate system defined by the at least two positioning marks;
a support, supporting the image capture device to capture a test image of the image chart and the at least two positioning marks; and
a computer system coupled to the image capture device, receiving the test image and verifying the quality of the image capture device by analyzing the test image with the coordinate system found in the test image, wherein the coordinate system in the test image is found by locating the at least two positioning marks.

16. The test platform as claimed in claim 15, wherein the number of the positioning marks is three and the positioning marks are round.

17. The test platform as claimed in claim 15, wherein the number of the positioning marks is four and t the positioning marks are round.

18. The test platform as claimed in claim 15, wherein the image chart comprises at least one test pattern.

19. The test platform as claimed in claim 15, wherein the color of the positioning marks is predetermined and different from a background color of the surface portion.

20. The test platform as claimed in claim 19, wherein the computer system locates the at least two positioning marks by acquiring the color of the pixel points of the test image to eliminate pixel points with color different from the positioning marks, filtering dispersed pixel points from the remaining pixel points of the test image according to the number of neighboring pixel points for each remaining pixel point within a predetermined distance, classifying the filtered pixel points of the test image into a plurality of clusters, determining a center pixel point of each cluster, and obtaining the positioning marks from the center pixel points according to the relative positions among the center pixel points.

21. The test platform as claimed in claim 20, wherein the computer system acquires the color of the pixel points of the test image to eliminate pixel points with color different from the positioning marks by obtaining the color of the positioning marks and the pixel points of the test image with respect to red, green and blue components thereof respectively, computing a first square error, a second square error and a third square error associated with the red, green and blue components of the positioning marks and each pixel point of the test image respectively, and eliminating a pixel point of the test image if the summation of the first, second and third square errors thereof exceeds a predetermined color threshold.

22. The test platform as claimed in claim 20, wherein the computer system filters dispersed pixel points from the remaining pixel points of the test image according to the number of neighboring pixel points for each remaining pixel point within a predetermined distance by calculating the number of neighboring pixel points of each remaining pixel point of the test image within the predetermined distance, and filtering a pixel point of the image if the calculated number of neighboring pixel points of the pixel point within the predetermined distance is less than a predetermined grouping threshold.

23. The test platform as claimed in claim 20, wherein the computer system further filters a cluster if the number of pixel points thereof is less than a predetermined clustering threshold after classifying.

24. The test platform as claimed in claim 20, wherein the computer system classifies the filtered pixel points of the test image into a plurality of clusters with a single link clustering process.

25. The test platform as claimed in claim 20, wherein the computer system determines a center pixel point for each cluster by calculating an average x-coordinate value and an average y-coordinate value of the x-coordinate and y-coordinate of the pixel points of each cluster respectively, and using the calculated average x-coordinate value and y-coordinate values of each cluster as the x-coordinate and y-coordinate of the center pixel point of each cluster.

26. The test platform as claimed in claim 20, wherein the computer system finds positioning marks by identifying central pixel points that have the largest x coordinate, the largest y coordinate, the smallest x coordinate and the smallest y coordinate; and if the number of position marks found is found less than four, the computer system further finds other one or more positioning marks by identifying central pixel points that have the largest distance to a line from two sides of the line, where the line is defined by two of the central pixel points with the largest distance therebetween.

27. The test platform as claimed in claim 15, wherein the image capture device is a digital camera.

28. The test platform as claimed in claim 15, wherein the image capture device is an electronic device having a camera.

29. An image card for testing an image capture device in a manufacturing process, comprising:
a card surface;
at least two positioning marks printed on the card surface defining a coordinate system; and
at least one test pattern printed on the card surface within an area defined by the at least two positioning marks;
wherein the image capture device captures a test image of the at least one test pattern and the at least two positioning marks and the test image is analyzed to verify the quality of the image capture device with the coordinate system in the test image found by locating the positioning marks in the test image.

30. The image card as claimed in claim 29, wherein the number of the positioning marks is three and the positioning marks are round.

31. The image card as claimed in claim 29, wherein the number of the positioning marks is four and the positioning marks are round.

32. The image card as claimed in claim 29, wherein the color of the positioning marks is predetermined and different from a background color of the card surface.

33. The image card as claimed in claim 29, wherein the at least two positioning marks is located by acquiring the color of the pixel points of the test image to eliminate pixel points with color different from the positioning marks, filtering dispersed pixel points from the remaining pixel points of the test image according to the number of neighboring pixel points for each remaining pixel point within a predetermined distance, classifying the filtered pixel points of the test image into a plurality of cluster, determining a center pixel point of each cluster, and obtaining the positioning marks from the center pixel points according to the relative positions among the center pixel points.

34. The image card as claimed in claim 33, wherein acquiring the color of the pixel points of the test image to eliminate pixel points with color different from the positioning marks comprises:
obtaining the color of the positioning marks and the pixel points of the test image with respect to red, green and blue components thereof respectively;
computing a first square error, a second square error and a third square error associated with the red, green and blue components of the positioning marks and each pixel point of the test image respectively; and
eliminating a pixel point of the test image if the summation of the first, second and third square errors thereof exceeds a predetermined color threshold.

35. The image card as claimed in claim 33, wherein filtering dispersed pixel points from the remaining pixel points of the test image according to the number of neighboring pixel points for each remaining pixel point within a predetermined distance comprises:
calculating the number of neighboring pixel points of each remaining pixel point of the test image within the predetermined distance; and
filtering a pixel point of the image if the calculated number of neighboring pixel points of the pixel point within the predetermined distance is less than a predetermined grouping threshold.

36. The image card as claimed in claim 33, wherein analyzing the test image further comprises after classifying, filtering a cluster if the number of pixel points thereof is less than a predetermined clustering threshold.

37. The image card as claimed in claim 33, wherein classifying comprises applying a single link clustering process.

38. The image card as claimed in claim 33, wherein determining a center pixel point of each cluster comprises:
calculating an average x-coordinate value and an average y-coordinate value of the x-coordinate and y-coordinate of the pixel points of each cluster respectively; and
using the calculated average x-coordinate value and y-coordinate values of each cluster as the x-coordinate and y-coordinate of the center pixel point of each cluster.

39. The image card as claimed in claim 33, wherein obtaining the positioning marks from the center pixel points according to the relative position among the center pixel points comprises:
a. finding positioning marks by identifying central pixel points that have the largest x coordinate, the largest y coordinate, the smallest x coordinate and the smallest y coordinate; and
b. if the number of position marks found in step a is less than four, finding other one or more positioning marks by identifying central pixel points that have the largest distance to a line from two sides of the line, where the line is defined by two of the central pixel points with the largest distance therebetween.

40. The method as claimed in claim 29, wherein the image capture device is a digital camera.

41. The method as claimed in claim 29, wherein the image capture device is an electronic device having a camera.
